(19) United States
(12) Patent Application Publication
(10) Pub. No.: US 2025/0156930 A1
(43) Pub. Date: May 15, 2025

(54) PREDICTING CAUSES OF CHURN AND ALLOCATING FULFILLMENT RESOURCES BASED ON PREDICTION

(71) Applicant: Maplebear Inc., San Francisco, CA (US)

(72) Inventors: Brent Scheibelhut, Toronto (CA); Shaun Navin Maharaj, Vaughan (CA); Madeline Mesard, New York, NY (US)

(21) Appl. No.: 18/510,554

(22) Filed: Nov. 15, 2023

(51) Int. Cl. G06Q 30/0601

(52) U.S. Cl. CPC G06Q 30/0635

(57) ABSTRACT

An online concierge system identifies churn of a customer, which occurs when the customer does not perform a specific action within a threshold time period. The online concierge system determines an event causing churn of the customer based on characteristics of the customer and attributes describing prior fulfillment of an order for the customer. To mitigate different events causing churn, the online concierge system maps areas of expertise of pickers for different aspects of order fulfillment to corresponding events. Through a trained picker scoring model, the online concierge system determines picker scores for different pickers fulfilling an order for a customer using characteristics of pickers, including an expertise, characteristics of the customer, and an event causing churn of the customer. Based on the picker scores, the online concierge system selects a specific picker for fulfilling a subsequent order from the customer.

### BACKGROUND

Online concierge systems receive orders for items from customers and allocate the orders to pickers, who fulfill the orders. To fulfill an order, a picker to whom the order was allocated obtains items in the order from a retailer. The picker subsequently delivers the obtained items to a customer.

Various events affect customer interaction with an online concierge system. For example, order fulfillment time, an amount charged by the online concierge system for fulfilling an order, a number of items in an order unable to be obtained, or other events negatively affect fulfillment of an order from a customer. The negative effect on order fulfillment for the customer decreases a likelihood of the customer subsequently engaging with the online concierge system. For example, a picker fulfilling an order for a customer later than a time interval specified in the order decreases a likelihood of the customer subsequently placing an order with the online concierge system or increases an amount of time until the customer places another order with the online concierge system. Such decrease of interaction by a customer with the online concierge system is used to identify “churn” of the customer. In various configurations, churn of a customer occurs if greater than a threshold time period lapses between the customer interacting with the online concierge system and the customer performing a specific action (e.g., places an order) with the online concierge system.

While an online concierge system may take one or more remedial actions to decrease a likelihood of churn of a customer, conventional systems fail to identify an event or event type that caused the churn of the customer. As different remedial actions affect different potential events, without accurately attributing a probability of churn of a customer occurring to an event causing the churn, the online concierge system is unable to implement an optimal remedial action to mitigate churn of a customer identified by conventional model. This prevents conventional online concierge systems from implementing a remedial action most likely to decrease churn of a customer after identifying the churn of the customer.

### SUMMARY

In accordance with one or more aspects of the disclosure, an online concierge system receives various interactions, or actions, from a customer over time. Example interactions with the online concierge system include placing an order with the online concierge system, requesting information about one or more items from the online concierge system, browsing items offered by one or more retailers via the online concierge system, providing feedback about fulfillment of an order to the online concierge system, or other exchanges of data between the customer and the online concierge system. The online concierge system uses occurrences of specific actions, such as placing orders with the online concierge system, to gauge user engagement with the online concierge system. For example, the online concierge system determines user engagement based on a frequency with which a customer performs a specific action or based on a length of time between successive occurrences of the specific action.

To maintain or to increase user interaction with the online concierge system, the online concierge system evaluates customer interactions over time to identify “churn” for a customer. Churn of a customer occurs when the customer fails to perform a specific action (e.g., placing an order) with the online concierge system within a threshold time period. For example, the online concierge system identifies churn for a customer when the customer performs the specific action and does not perform the specific action again within the threshold time period. As another example, the online concierge system identifies churn of the customer in response to the customer performing an interaction and failing to perform the specific action within the threshold time period of performing the interaction.

In other embodiments, the online concierge system identifies churn of a customer by applying a churn prediction model to prior interactions of the customer with the online concierge system and attributes describing prior fulfilling of an order from the customer. Example attributes describing fulfillment of the order may include characteristics of a picker who fulfilled an order for the customer and attributes of the order (e.g., items included in the order, a retailer from which the order was fulfilled, a time when the order was fulfilled, etc.). The churn prediction model determines a probability of churn occurring for the customer (i.e., a probability of the customer failing to perform the specific action within the threshold time period) based on the prior interactions of the customer with the online concierge system and the attributes describing fulfillment of the order. For example, the online concierge system determines weights comprising the churn prediction model generated through a training process. In various embodiments, the training process includes: applying the churn prediction model to a plurality of training examples, each training example including prior interactions with the online concierge system by a customer and attributes describing prior fulfillment of an order for the customer, with a label applied to a training example indicating whether churn occurred for the customer after the prior fulfillment of the order, comparing an output of the churn prediction model when applied to a training example to the label associated with the training example, and updating weights comprising the churn prediction model through a back-propagation process. The weights may be stored on one or more computer-readable media, and are subsequently used by the online concierge system when applying the churn prediction model to new customer interactions and attributes describing order fulfillment for a customer. The online concierge system identifies churn of the customer in response to the probability of the customer failing to perform the specific action within the threshold time period equaling or exceeding a threshold probability in various embodiments.

Identifying churn of a customer indicates a decrease in frequency with which the customer interacts with the online concierge system. To increase the frequency with which the customer interacts with the online concierge system after identifying churn of the customer, the online concierge system applies a churn classification model to characteristics of the customer, an order received from the customer, and attributes describing fulfillment of the order, such as characteristics of a picker fulfilling the order. In various embodiments, the order received from the customer is an order received by the online concierge system most recently before identification of the churn of the customer. Further, the characteristics of the customer may include one or more additional orders received from the customer.

For example, the online concierge system determines weights comprising the churn classification model generated through a training process. In various embodiments, the training process includes: applying the churn classification model to a plurality of classification training examples, each classification training example including characteristics of a customer for whom churn was identified, an order received from the customer for whom churn was identified, and attributes describing fulfillment of the order, with a label applied to a classification training example specifying an event causing the churn of the customer, comparing an output of the churn classification model when applied to a classification training example to the label associated with the classification training example, and updating weights comprising the churn classification model through a back-propagation process. The weights may be stored on one or more computer-readable media, and are subsequently used by the online concierge system when applying the churn classification model to new characteristics of a customer, an order received from the customer, and attributes describing fulfillment of the order.

The churn classification model determines an event to which churn of the customer is attributed. An “event” identifies one or more factors affecting fulfillment of an order, such as one or more factors delaying fulfillment of an order or preventing a picker from obtaining all items included in an order. Example events causing churn of the customer include: fulfilling an order later than a time interval specified by the order, inclusion of replacement items in the order rather than items identified by the order, inadequate communication between a picker fulfilling the order with the customer, an amount of compensation the customer paid the online concierge system 140 for fulfilling the order, a number of items included in the order that were not obtained by the picker, or other actions affecting fulfillment of an order.

To mitigate churn identified for the customer, the online concierge system may perform one or more remedial actions to mitigate an event to which the churn was attributed, with a remedial action reducing a likelihood of the event occurring when fulfilling a subsequent order from the customer. As different remedial actions mitigate different events, determining the event to which the churn was attributed allows the online concierge system to implement a more optimal remedial action that decreases a likelihood of the event to which churn was attributed occurring during fulfillment of a subsequent order. In various embodiments, the online concierge system mitigates churn of the customer by tailoring selection of a picker for fulfilling a subsequent order from the customer based on the event to which the churn was attributed.

In various embodiments, the online concierge system maintains a mapping between events to which churn of a customer is attributed and areas of expertise of pickers. The online concierge system determines one or more areas of expertise for a picker based on characteristics of the picker and stores the one or more areas of expertise as one or more characteristics of the picker. An expertise of the picker identifies a skill of the picker when fulfilling an order based on prior orders fulfilled by the picker. Example areas of expertise include: selecting items from a specific retailer, order fulfillment time, selection of items with a specific item category, languages understood by the picker, selection of items for specific occasions (e.g., holidays, birthdays, etc.). In some embodiments, the online concierge system determines one or more areas of expertise for a picker by applying a trained picker expertise model to characteristics of the picker, with the trained picker expertise identifying one or more areas of expertise for the picker based on the characteristics of the picker. Alternatively, the online concierge system maintains a set of rules, with each rule corresponding to an expertise and including one or more corresponding criteria. In response to characteristics of the picker satisfying at least a threshold amount of criteria in a rule, the online concierge system associates an expertise corresponding to the rule with the picker.

Mapping an expertise of a picker to an event indicates the expertise mitigates effects of the event on order fulfillment. For example, the mapping associates an event of inclusion of items in an order with which the customer was dissatisfied with an expertise of obtaining items from a specific retailer or with an expertise of obtaining items in a specific item category. As another example, the mapping associates an event of fulfilling an order later than a time interval included in the order with an expertise of rapid fulfillment of orders.

To select a picker for fulfilling an order from the customer after identifying churn of the customer, the online concierge system trains a picker scoring model. The picker scoring model receives characteristics of the customer, one or more prior orders received from the customer, the event to which churn of the customer was attributed, and characteristics of a picker. The characteristics of a picker include one or more areas of expertise of the picker, with other example characteristics of a picker including an availability of the picker for fulfilling orders, fulfillment of one or more prior orders by the picker, whether the picker fulfilling one or more prior orders decreased an amount of time for customers corresponding to the prior orders placing subsequent orders, or other characteristics of the picker affecting order fulfillment. In various embodiments, the prior orders received from the customer include an order received most recently before identifying churn of the customer, as well as one or more additional orders. The additional orders may have at least a threshold measure of similarity to the order received most recently before identifying churn of the customer. For example, the online concierge system retrieves additional orders received before identifying churn of the customer, with each additional order having an embedding with a threshold measure of similarity (e.g., dot product, cosine similarity) to an embedding of the order received most recently before identifying churn of the customer.

In various embodiments, the online concierge system determines weights comprising the picker scoring model through a training process. In various embodiments, the training process includes: applying the picker scoring model to a plurality of score training examples, each training example including characteristics of a customer, one or more prior orders received from the customer, the event to which churn of the customer was attributed, and characteristics of a picker, with a label applied to a score training example label applied to the score training example indicating whether the customer in the score training example performed the specific action with the online concierge system within the threshold time period when the picker included in the score training example fulfilled an order in the score training example for the customer in the score training example, comparing an output of the picker scoring model when applied to a score training example to the label associated with the score training example, and updating weights comprising the picker scoring model through a back-propagation process. The weights may be stored on one or more computer-readable media, and are subsequently used by the online concierge system when applying the picker scoring model to new characteristics of a customer, one or more prior orders received from the customer, an event to which churn of the customer was attributed, and characteristics of a picker.

Based on the characteristics of the customer, the one or more prior orders received from the customer, the event to which churn of the customer was attributed, and the characteristics of a picker, the picker scoring model determines a picker score for the picker. The picker score for the picker is a probability that the picker fulfilling a subsequent order for the customer causes the customer to perform the specific action with the online concierge system (e.g., place an additional order with the online concierge system) within the threshold time period of the subsequent order. For example, the picker score for a picker is a probability that the customer places an additional order within the threshold time period of a subsequent order from the customer that the picker fulfills.

In various embodiments, a picker score for a picker is higher when an expertise of the picker is mapped to the event to which churn of the customer is attributed. This allows the picker score to account for varying effects of different areas of expertise of a picker on mitigating churn caused by different events. For example, a picker with an expertise of obtaining items at a specific retailer has a higher picker score when the event to which churn of the customer is attributed is selection of unsatisfactory items from the specific retailer or is inability to obtain items from the specific retailer. Hence, pickers with different areas of expertise have different picker scores based on the event to which churn of the customer is attributed.

In various embodiments, the online concierge system applies the picker scoring model to each picker of a set of pickers, generating a picker score for each picker of the set. Based on the picker scores, the online concierge system selects a specific picker for fulfilling a subsequent order from the customer. For example, the online concierge system selects a specific picker having a maximum picker score to fulfill a subsequent order from the customer. As picker scores account for an event to which churn of a customer was attributed and for expertise of a picker, selection of the specific picker is based in part on the event to which churn of a customer is attributed.

In some embodiments, the online concierge system transmits an offer to the customer including a discount or other benefit to the customer for a subsequent order, with the specific picker selected to fulfill an order in response to the offer. The offer comprises a notification message transmitted from the online concierge system to a customer client device of the customer including a discount or other compensation from the online concierge system to the customer and an interface element that, when selected by the customer prompts the customer to provide information for an order to be fulfilled by the specific picker.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for selecting a picker for fulfilling an order for a customer of an online concierge system who has at least a threshold probability of not performing a specific action with the online concierge system within a threshold time period, in accordance with some embodiments.

FIG. 4 is a process flow diagram of a method selecting a picker for fulfilling an order for a customer of an online concierge system who has at least a threshold probability of not interacting with the online concierge system within a threshold time period, in accordance with some embodiments.

### DETAILED DESCRIPTION

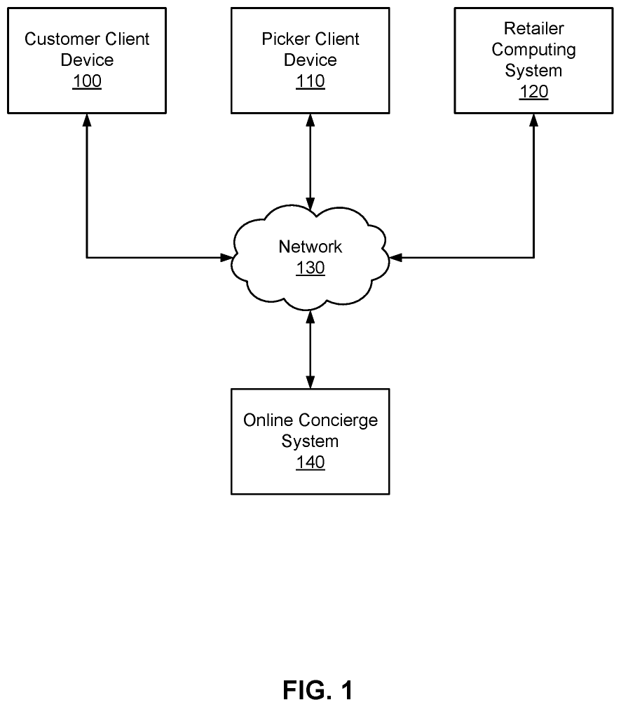

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

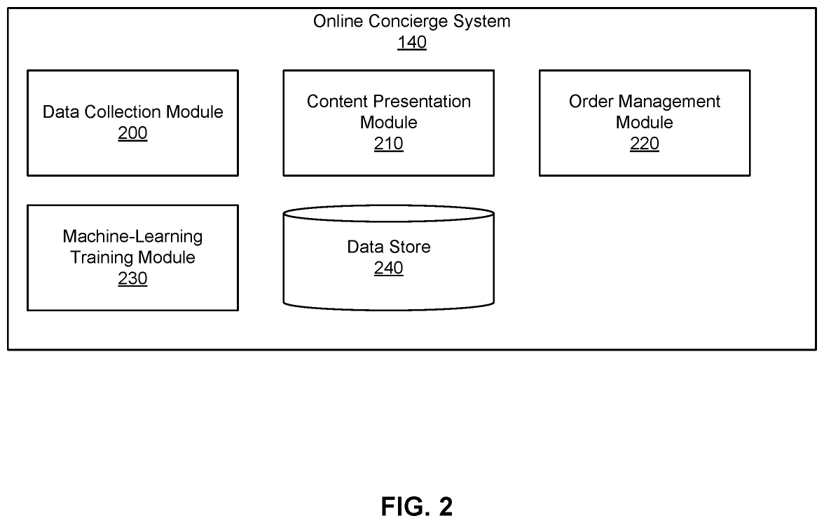

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

In various embodiments, picker data also includes one or more areas of expertise of a picker. An expertise of a picker identifies a skill of the picker when fulfilling an order based on prior orders fulfilled by the picker. Example areas of expertise include: selecting items from a specific retailer, order fulfillment time, selection of items with a specific item category, languages understood by the picker, selection of items for specific occasions (e.g., holidays, birthdays, etc.) based on characteristics of the picker and stores the one or more areas of expertise as one or more characteristics of the picker. In some embodiments, the data collection module 200 determines one or more areas of expertise for a picker by applying a trained picker expertise model to characteristics of the picker, with the trained picker expertise identifying one or more areas of expertise for the picker based on the characteristics of the picker. Alternatively, the data collection module 200 maintains a set of rules, with each rule corresponding to an expertise and including one or more corresponding criteria. In response to characteristics of the picker satisfying at least a threshold amount of criteria in a rule, the data collection module 200 associates an expertise corresponding to the rule with the picker.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

In various embodiments, the order management module 220 also identifies churn of a customer. “Churn” occurs when a customer fails to perform a specific action (e.g., placing an order) with the online concierge system 140 within a threshold time period. In various embodiments, the order management module 220 identifies churn of a customer in response to determining the threshold time period has passed from the customer interacting with the online concierge system 140 without the customer performing the specific action. For example, the order management module 220 identifies churn of a customer in response to at least the threshold time period lapsing between the customer performing the specific interaction and the customer again performing the specific action. Alternatively, the order management module 220 applies a churn prediction model to prior interactions by a customer with the online concierge system 140 and customer characteristics. The churn prediction model outputs a probability of churn occurring for the customer (i.e., a probability of the customer failing to perform the specific action within the threshold time period). The order management module 220 identifies churn of the customer in response to the probability of churn occurring output by the churn prediction model equaling or exceeding a threshold probability.

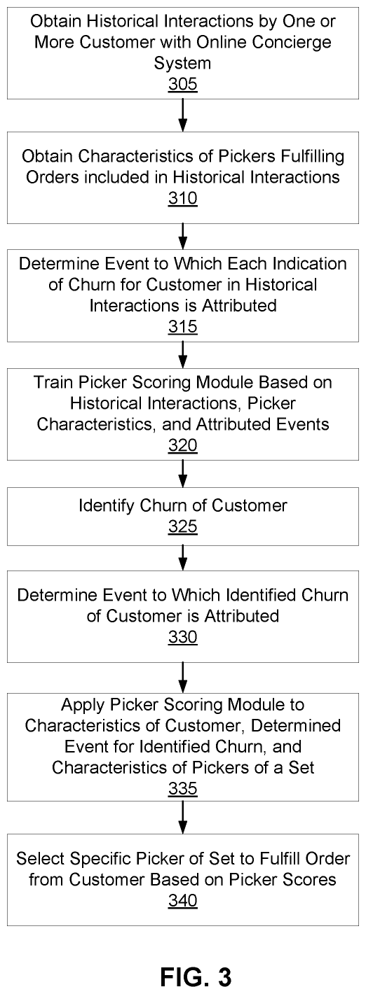

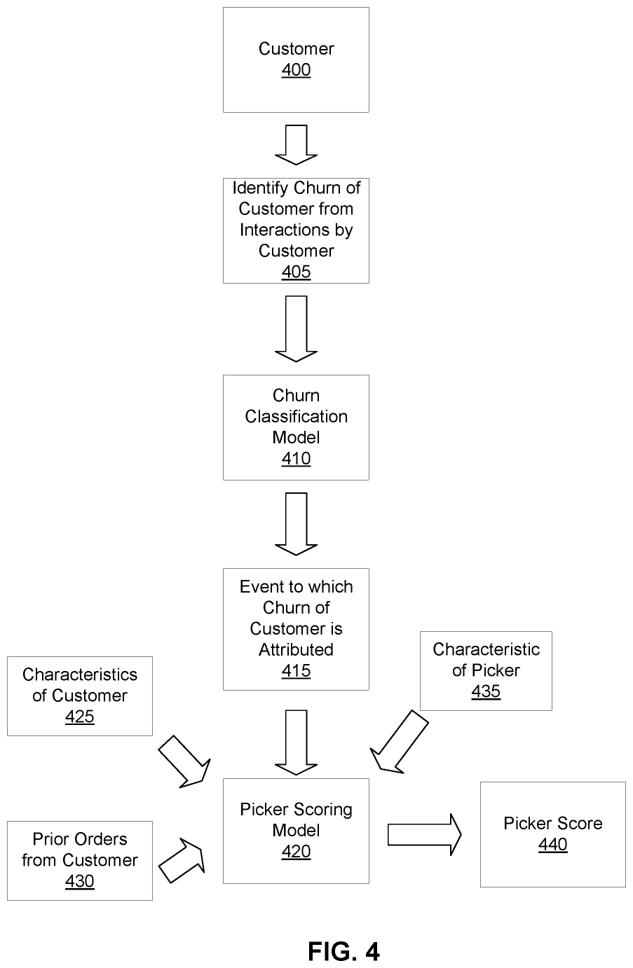

In response to identifying churn of a customer, the order management module 220 determines an event causing the churn. An “event” identifies one or more factors affecting fulfillment of an order, such as one or more factors delaying fulfillment of an order or preventing a picker from obtaining all items included in an order. Example events causing churn of the customer 400 include: fulfilling an order later than a time interval specified by the order, inclusion of replacement items in the order rather than items identified by the order, inadequate communication between a picker fulfilling the order with the customer, an amount of compensation the customer paid the online concierge system 140 for fulfilling the order, a number of items included in the order that were not obtained by the picker, or other actions affecting fulfillment of an order. Occurrence of one or more events when an order is fulfilled for a customer may decrease a likelihood of a customer placing a subsequent order with the online concierge system 140 or may decrease a frequency with which the customer places orders with the online concierge system 140. To prevent such decreases in customer interaction from one or more events, in response to identifying churn of a customer, the order management module 220 determines an event to which the churn of the customer is attributed, as further described below in conjunction with FIGS. 3 and 4. Such attribution allows the order management module 220 to identify an event most likely to have caused the identified churn of the customer.

To mitigate churn of a customer, which increases a probability of the customer performing the specific action within the threshold time period, in response to identifying churn of a customer, the order management module 220 applies a picker scoring model to the event to which churn of the customer is attributed, characteristics of the customer, characteristics of a picker, and one or more prior orders from the customer to generate a picker score for the picker. The order management model 220 applies the picker scoring model to and characteristics of different pickers of a set, resulting in a picker score for different pickers of the set. As further described below in conjunction with FIGS. 3 and 4, the picker score for a picker is a probability of the customer performing a specific action within a threshold time period of the picker fulfilling a subsequent order from the customer. For example, the picker score for a picker is a probability that the customer places another order with the online concierge system 140 within the threshold time period of a time when the picker fulfils the order for the customer. Based on the picker scores for each of a set of pickers, the order management module 220 selects a specific picker to fulfill an order. For example, the order management module 220 selects a picker having a maximum picker score to fulfill an order from the customer in response to identifying churn of the customer. As further described below in conjunction with FIGS. 3 and 4, the picker scoring model accounts for various characteristics of a picker and an event to which churn of a customer is attributed to identify a picker having expertise or experience most suitable to mitigate the event to which the churn of the customer was attributed.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The machine learning training module 230 trains a picker scoring model based on historical interactions by a customer with the online concierge system 140, characteristics of a picker, one or more prior orders from the customer, and an event to which churn of the customer is attributed. As further described above, churn of a customer is identified when the customer fails to perform a specific action (e.g., places an order) with the online concierge system 140 within a threshold time period or when a probability of the customer failing to perform the specific action within the threshold time period equals or exceeds a threshold probability. In various embodiments, characteristics of the customer include an order received from the customer most recently before churn of the customer was identified, a frequency with which the online concierge system 140 received orders from the customer, a frequency with which the customer interacts with the online concierge system 140, or other characteristics describing the customer or orders received from the customer. Characteristics of a picker include an expertise of the picker, an availability of the picker for fulfilling orders, fulfillment of one or more prior orders by the picker, whether the picker fulfilling one or more prior orders decreased an amount of time for customers corresponding to the prior orders placing subsequent orders, or other characteristics of the picker affecting order fulfillment. An expertise of the picker identifies a skill of the picker when fulfilling an order based on prior orders fulfilled by the picker. Example areas of expertise include: selecting items from a specific retailer, order fulfillment time, selection of items with a specific item category, languages understood by the picker, selection of items for specific occasions (e.g., holidays, birthdays, etc.). Including an expertise of a picker as a characteristic of the picker allows the picker scoring model to account for effects of an expertise of the picker to mitigate an event to which churn of a customer is attributed.

As further described below in conjunction with FIGS. 3 and 4, when training the picker scoring model, the machine learning training module 230 retrieves historical interactions by one or more customers with the online concierge system 140 and historical fulfillment of orders by various pickers from the data store 240. From the historical interactions by the customers and the historical fulfillment of orders by pickers, the machine learning training module 230 generates a score training dataset that includes multiple score training examples. Each score training example includes an event to which churn of a customer is attributed, characteristics of the customer, one or more prior orders received from the customer, and characteristics of a picker, with a label applied to a score training example indicating whether the customer in the training example performed a specific action with the online concierge system 140 within the threshold time period of the picker included in the score training example fulfilling an order for the customer included in the score training example. In various embodiments, the label has a first value in response to customer in the score training example performing a specific action with the online concierge system 140 within the threshold time period of the picker included in the score training example fulfilling an order for the customer included in the score training example, while the label has a second value in response to the customer in the score training example failing to perform the specific action with the online concierge system 140 within the threshold time period of the picker included in the score training example fulfilling an order for the customer included in the score training example. As further described below in conjunction with FIGS. 3 and 4, the machine learning training module 230 trains the picker scoring model by applying the picker scoring model to a score training example, comparing an output of the picker scoring model to the label associated with the training example, and updating weights associated for the picker scoring model through a back-propagation process until one or more criteria are satisfied.

Additionally, the machine learning training model 230 trains a churn classification model to attribute an event to churn identified for a customer. The event to which churn is attributed identifies a most likely cause of churn. The churn classification model receives a combination of characteristics of a customer, an order received from the customer, and attributes describing fulfillment of the order, such as characteristics of a picker fulfilling the order, and determines an event to which churn of the customer is attributed. Hence, the weights comprise a set of parameters used by the churn classification model to transform the input data-characteristics of a customer, including an order received from the customer, and attributes describing fulfillment of the order-into an event to which churn of the customer is attributed. The machine learning training model 230 trains the churn classification model by applying the churn classification model to a training example, comparing an output of the churn classification model to the label associated with the training example, and updating weights associated for the churn classification model through a back-propagation process until one or more criteria are satisfied, as further described below in conjunction with FIG. 3.

In various embodiments, the machine learning training model 230 also trains and stores a churn prediction model that determines a probability of churn occurring for a customer (i.e., a probability of the customer failing to perform the specific action within the threshold time period) based on the prior interactions of the customer with the online concierge system and the attributes describing fulfillment of a prior order from the customer. In various embodiments, the machine learning training module 230 determines weights comprising the churn prediction model generated through a training process. The training process includes: applying the churn prediction model to a plurality of training examples, each training example including prior interactions with the online concierge system by a customer and attributes describing prior fulfillment of an order for the customer, with a label applied to a training example indicating whether churn occurred for the customer after the prior fulfillment of the order. When performing the training process, the machine learning training module 230 compares an output of the churn prediction model when applied to a training example to the label associated with the training example and updates weights comprising the churn prediction model through a back-propagation process. Training the churn prediction model allows the online concierge system 140 to predict a probability of churn of a customer based on prior interactions by the customer with the online concierge system and attributes describing fulfillment of an order for the customer.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 is a flowchart of a method for selecting a picker for fulfilling an order for a customer of an online concierge system 140 who has at least a threshold probability of failing to perform a specific action with the online concierge system 140 within a threshold time period, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 obtains 305 historical interactions with the online concierge system 140 by one or more customers. For example, the online concierge system 140 selects a customer and retrieves historical interactions with the online concierge system 140 by the selected customer from the data store 240. The online concierge system 140 obtains 305 historical interactions with the online concierge system 140 from multiple customers in various embodiments. In various embodiments, the obtained historical interactions occurred during a specific time period. Example historical interactions by the customer with the online concierge system 140 include orders previously received from the customer, information describing orders fulfilled for the customer by the online concierge system 140 (e.g., a number of items in an order that were not found by a picker, an amount spent by the customer on an order, whether an order was fulfilled within a time interval specified by the order, a rating the customer gave to fulfillment of an order, a time between orders received from the customer, a number of items included in each order from the customer, etc.), and may include other interactions by the customer with the online concierge system 140. In various embodiments, characteristics of a customer are obtained along with historical interactions by the customer with the online concierge system 140,

The historical interactions obtained 305 for one or more customers include occurrences of churn of customers. “Churn” of a customer occurs when the customer fails to perform a specific action (e.g., placing an order) with the online concierge system 140 within a threshold time period. For example, churn of a customer occurs when the threshold time period passes between a customer performing the specific action and the customer again performing the specific action. As another example, the online concierge system 140 determines churn of a customer based on historical interactions obtained 305 for the customer including at least the threshold time period between an interaction by the customer with the online concierge system 140 and the customer performing a specific action with the online concierge system 140 (e.g., greater than the threshold time period between the online concierge system 140 receiving an order from the customer and the online concierge system 140 receiving an additional order from the customer). The online concierge system 140 stores an indication that churn of a customer occurred in association with historical interactions for the customer corresponding to the churn of the customer. This identifies loss of interaction with the online concierge system 140 by the customer.

Additionally, the online concierge system 140 obtains 310 characteristics of pickers who previously fulfilled one or more orders for customers included in the historical interactions. For example, the online concierge system 140 identifies a picker who fulfilled an order in historical interactions for a customer and obtains 310 characteristics of the picker who fulfilled the order. Characteristics of a picker include an expertise of the picker, an availability of the picker for fulfilling orders, fulfillment of one or more prior orders by the picker, whether fulfillment of an order from a customer by a picker decreased an amount of time for the online concierge system receiving a subsequent order from the customer, or other characteristics describing order fulfillment capability of the picker. In various embodiments, the online concierge system 140 obtains 310 characteristics of pickers from the data store 240 or from another storage location. The characteristics of pickers may be based on prior order fulfillment by pickers during a specific time interval.

In various embodiments, the expertise of a picker obtained 310 as a characteristic of the picker is determined by the online concierge system 140 based on prior order fulfillment by the picker and other characteristics of the picker. Example characteristics of a picker for determining an expertise of the picker include: languages associated with the picker, dietary preferences of the picker, a number of orders previously fulfilled by the picker, feedback received from customers for the picker fulfilling orders from specific retailer, feedback received from customers for the picker fulfilling orders for specific occasions (e.g., holidays, birthdays, anniversaries, etc.), ratings for the picker from customers, item categories for items obtained by the picker for fulfilled orders, dietary preferences corresponding to items obtained by the picker for fulfilled orders, items the picker previously obtained when fulfilling prior orders, or other information describing prior fulfillment of orders by the picker. In some embodiments, the online concierge system 140 determines one or more areas of expertise for a picker by applying a trained picker expertise model to characteristics of the picker, with the trained picker expertise model identifying one or more expertise for the picker based on the characteristics of the picker. The picker expertise model may be trained through a backpropagation process, such as further described above in conjunction with FIG. 2. Alternatively, the online concierge system 140 maintains a set of rules, with each rule corresponding to an expertise and including one or more corresponding criteria. In response to characteristics of the picker satisfying at least a threshold amount of criteria in a rule, the online concierge system 140 associates an expertise corresponding to the rule with the picker.

For each indication that churn of a customer occurred from historical interactions for the customer, the online concierge system 140 determines 315 an event to which the churn of the customer is attributed. As further described above in conjunction with FIG. 2, occurrence of one or more events when a picker fulfills an order for a customer may increase an amount of time between the order and the online concierge system 140 receiving a subsequent order from the customer. An “event” identifies one or more factors affecting fulfillment of an order, such as one or more factors delaying fulfillment of an order or preventing a picker from obtaining all items included in an order. Example events causing churn of the customer include: fulfilling an order later than a time interval specified by the order, inclusion of replacement items in the order rather than items identified by the order, inadequate communication between a picker fulfilling the order with the customer, an amount of compensation the customer paid the online concierge system 140 for fulfilling the order, a number of items included in the order that were not obtained by the picker, or other actions affecting fulfillment of an order. Different remedial actions by the online concierge system 140 remedy different events, so determining 315 an event to which churn of a customer is attributed allows the online concierge system 140 to determine a remedial action most likely to mitigate the event causing churn of the customer.

In various embodiments, the online concierge system 140 determines 315 the event to which churn of a customer is attributed by applying a trained churn classification model to characteristics of a customer, an order fulfilled for the customer, and to attributes describing fulfillment of the order received from the customer, which include one or more characteristics of a picker who fulfilled the order for the customer. Characteristics of the customer include the order received from the customer, one or more previously fulfilled orders from the customer, a frequency with which the online concierge system 140 received orders from the customer, a frequency with which the customer interacts with the online concierge system 140, or other characteristics describing the customer or orders received from the customer. Characteristics of a picker include an expertise for the picker, an availability of the picker for fulfilling orders, fulfillment of one or more prior orders by the picker, whether the picker fulfilling one or more prior orders decreased an amount of time for customers corresponding to the prior orders placing subsequent orders, or other characteristics of the picker affecting order fulfillment. Based on characteristics of the customer and attributes describing fulfillment of an order for the customer, the churn classification model outputs an event affecting fulfilment of the order to which churn of the customer is attributed. Hence, the churn classification model outputs an event causing churn of a customer.

In various embodiments, the churn classification model comprises a set of weights stored on a non-transitory computer readable storage medium in various embodiments. For training, the online concierge system 140 initializes a network of a plurality of layers comprising the churn classification model, with each layer including one or more weights. The churn classification model receives a combination of characteristics of a customer, an order received from the customer, and attributes describing fulfillment of the order, such as characteristics of a picker fulfilling the order, and determines an event to which churn of the customer is attributed. Hence, the weights comprise a set of parameters used by the churn classification model to transform the input data-characteristics of a customer, an order received from the customer, and attributes describing fulfillment of the order-into an event to which churn of the customer is attributed.

After initializing the set of weights comprising the churn classification model, the online concierge system 140 applies the churn classification model to multiple training examples of a training dataset generated from the historical interactions by customers and characteristics of pickers. In various embodiments, each training example includes characteristics of a customer associated with an indication of churn, an order received from the customer associated with the indication of churn, and attributes describing fulfillment of the order for the customer associated with the indication of churn. A label is applied to each training example, with a label specifying an event causing the churn of the customer in the training example. In various embodiments, the label is obtained from information received from customers associated with an indication of churn, such as a selection of an event by a customer in response to a survey from the online concierge system 140 to the customer requesting information about churn of the customer. Applying the churn classification model to multiple training examples generates the parameters (e.g., the weights) for the churn classification model. When applied to a training example, the churn classification model generates a predicted event to which churn of the customer included in the training example is attributed.

For each training example to which the churn classification is applied, the online concierge system 140 generates a score comprising an error term based on the predicted event to which churn of the customer included in the training example is attributed and the label applied to the training example. The error term is larger when a difference between the predicted event to which churn of the customer included in the training example is attributed and the label applied to the training example is larger and is smaller when the difference between the predicted event to which churn of the customer included in the training example is attributed and the label applied to the training example is smaller. In various embodiments, the online concierge system 140 generates the error term using a loss function based on a difference between the predicted event to which churn of the customer included in the training example is attributed and the label applied to the training example using a loss function. Example loss functions include a mean square error function, a mean absolute error, a hinge loss function, and a cross-entropy loss function.

The online concierge system 140 backpropagates the error term to update the set of parameters comprising the churn classification model and stops backpropagation in response to the error term, or to the loss function, satisfying one or more criteria. For example, the online concierge system 140 backpropagates the error term through the churn classification model to update parameters of the churn classification model until the error term has less than a threshold value. For example, the online system 140 may apply gradient descent to update the set of parameters. The online concierge system 140 stores the set of parameters comprising the churn classification model on a non-transitory computer readable storage medium after stopping the backpropagation.

In various embodiments, the churn classification model differently determines 315 an event to which churn of a customer is attributed. For example, the churn classification model may determine an embedding for a customer for whom churn was identified based on characteristics of the customer and historical interactions by the customer with the online concierge system 140. The online concierge system 140 may associate a customer with an event for churn of the customer based on measure of similarity between an embedding for the customer and embeddings corresponding to different events. An embedding for an event may be based on embeddings of other customers to which the event was determined as causing churn of the customers. For example, an event with an embedding having a maximum measure of similarity (e.g., cosine similarity, dot product) to an embedding for a customer for whom churn was identified is determined 315 as the event to which churn of the customer is attributed.

Determining 315 an event to which churn of a customer is attributed allows the online concierge system 140 to determine how to optimally mitigate the churn of the customer. In various embodiments, the online concierge system 140 mitigates churn of a customer by selecting a picker having a particular expertise to fulfill a subsequent order received from the customer. In various embodiments, the online concierge system 140 maintains a mapping of events to which churn of a customer is attributed to areas of expertise of pickers. Such a mapping allows the online concierge system 140 to identify a picker with an expertise most likely to compensate for the event causing a user to churn. For example, the mapping associates an event of inclusion of items in an order with which the customer was dissatisfied with an expertise of obtaining items from a specific retailer or with an expertise of obtaining items in a specific item category. As another example, the mapping associates an event of fulfilling an order later than a time interval included in the order with an expertise of rapid fulfillment of orders. The mapping between areas of expertise and events may be updated over time in various embodiments.

To determine a picker for fulfilling an order from a customer to mitigate churn of the customer, the online concierge system 140 generates a score training dataset for a picker scoring model based on the historical interactions by customers and characteristics of pickers. The score training dataset includes multiple score training examples, with each score training example including characteristics of a customer, one or more orders received from the customer, an event attributed to churn of the customer, and characteristics of a picker who fulfilled an order for the customer. A label applied to each score training example indicates whether the customer performed a specific action with the online concierge system 140 (e.g., placed an additional order with the online concierge system 140) within a threshold time period when the picker fulfilled an order for the customer (i.e., the label indicates whether churn of the customer occurred). For example, the label applied to a score training example has a first value in response to the online concierge system 140 storing an indication that churn occurred for a customer from historical interactions by the customer in the score training example when a picker included in the score training example fulfilled an order for the customer and has a second value in response to the online concierge system 140 not storing an indication that churn occurred for the customer from historical interactions by the customer in the score training example when a picker included in the score training example fulfilled an order for the customer.

The picker scoring model receives characteristics of a customer, one or more orders received from the customer, including an order from the customer occurring nearest to when churn was identified for the customer, an event to which churn of the customer is attributed, and characteristics of a picker as inputs. Based on the inputs, the picker scoring model generates a picker score for the picker, with the picker score comprising a probability that the picker fulfilling an order for the customer causes the customer to perform specific action with the online concierge system 140 (e.g., place an additional order with the online concierge system 140) within the threshold time period. The online concierge system 140 trains 320 the picker scoring module by initializing a set of weights comprising the picker scoring model and applying the picker scoring model to multiple score training examples. As further described above, each score training example includes characteristics of a customer, one or more orders received from the customer, an event attributed to churn of the customer, and characteristics of a picker who fulfilled an order for the customer, with a label applied to the score training example indicating whether the customer performed a specific action with the online concierge system 140 (e.g., placed an additional order with the online concierge system 140) within a threshold time period when the picker fulfilled an order for the customer.

Applying the picker scoring model to a score training example generates a picker score that is a predicted probability that a picker in the score training example fulfilling an order included in the score training example for a customer included in the score training example causes the customer included in the score training example to subsequently perform a specific action with the online concierge system 140 (e.g., place an additional order with the online concierge system 140) in less than the threshold time period. For each score training example to which the picker scoring model is applied, the online concierge system 140 generates a score comprising an error term based on the predicted probability generated by the picker scoring model and the label applied to the score training example. The error term is larger when a difference between the predicted probability generated by the picker scoring model and the label applied to the training example is larger and is smaller when the difference between the predicted probability generated by the picker scoring model and the label applied to the score training example is smaller. In various embodiments, the online concierge system 140 generates the error term using a loss function based on a difference between the predicted probability generated by the picker scoring model and the label applied to the training example using a loss function. Example loss functions include a mean square error function, a mean absolute error, a hinge loss function, and a cross-entropy loss function.

The online concierge system 140 backpropagates the error term to update the set of parameters comprising the picker scoring model and stops backpropagation in response to the error term, or to the loss function, satisfying one or more criteria. For example, the online concierge system 140 backpropagates the error term through the picker scoring model to update parameters of the picker scoring model until the error term has less than a threshold value. For example, the online system 140 may apply gradient descent to update the set of parameters. The online concierge system 140 stores the set of parameters comprising the picker scoring model on a non-transitory computer readable storage medium after stopping the backpropagation.

After training 320 the picker scoring model, the online concierge system 140 identifies 325 churn of a customer. For example, the online concierge system 140 identifies 325 churn of the customer in response to determining at least the threshold time period lapsed between the customer interacting with the online concierge system 140 and the customer performing a specific action (e.g., placing an order) with the online concierge system 140. In some embodiments, the online concierge system 140 identifies 325 churn of the customer in response to at least the threshold time period passing from a time between the customer performing the specific action and the customer performing the specific action again. For example, the online concierge system 140 identifies 325 churn of the customer in response to at least the threshold time period lapsing between the online concierge system 140 receiving an order from the customer without the online concierge system 140 and receiving an additional order from the customer.

Alternatively, the online concierge system 140 identifies 325 churn of the customer by applying a trained churn prediction model to prior interactions of the customer with the online concierge system 140. The prior interactions of the customer with the online concierge system 140 include characteristics of the customer and attributes describing fulfillment of an order for the customer in various embodiments. The attributes describing fulfillment of the order may include characteristics of a picker who fulfilled an order for the customer and attributes of the order. The churn prediction model determines a probability of churn occurring for the customer (i.e., a probability of the customer failing to perform the specific action within the threshold time period) based on the prior interactions of the customer with the online concierge system 140 and the attributes describing fulfillment of the order by the online concierge system 140. In various embodiments, the churn prediction model is trained using a backpropagation process using training examples as further described above in conjunction with FIG. 2. The online concierge system 140 identifies 325 churn of the customer in response to the probability of churn occurring for the customer determined by the churn prediction model equaling or exceeding a threshold probability in various embodiments.

As certain orders from customers may be sporadic orders placed because of occasions (e.g., birthdays, holidays, anniversaries, etc.) or atypical conditions for the customer, having greater than the threshold time period pass between a sporadic order and another order from a customer does not indicate churn of the customer. A sporadic order is infrequently placed, so greater than the threshold time period passing between a sporadic order from the customer and the customer performing the specific action (e.g., placing another order) is not churn of the customer. In various embodiments, the online concierge system 140 applies a trained order classification model to characteristics of the customer and to attributes of an order from the customer to determine whether the order is a sporadic order. In response to determining an order is a sporadic order, the online concierge system 140 does not identify churn of the customer in response to greater than the threshold time period passing between the sporadic order and the online concierge system 140 receiving the specific action, such as another order, from the customer.

The order classification model comprises a set of weights stored on a non-transitory computer readable storage medium in various embodiments. For training, the online concierge system 140 initializes a network of a plurality of layers comprising the order classification model, with each layer including one or more weights. The order classification model receives characteristics of the customer and attributes of an order received from the customer and determines whether the order is a sporadic order. Hence, the weights comprise a set of parameters used by the order classification model to transform the input data-characteristics of a customer and attributes of an order received from the customer-into an indication whether the order is a sporadic order. Example characteristics of the customer received by the order classification model include a frequency with which the customer previously placed orders with the online concierge system 140, a frequency with which the customer accesses the online concierge system 140, a length of time the online concierge system 140 has maintained an account for the customer, or other information describing a frequency or a duration of interaction by the customer with the online concierge system 140. Example attributes of the order include attributes of the items included in the order, such as item categories of items included in the order, types of items included in the order, or other descriptive information of items included in the order.

After initializing the set of weights comprising the order classification model, the online concierge system 140 applies the order classification model to multiple order classification training examples of an order classification training dataset generated from historical orders received from customers and characteristics of customers from whom the orders were received. In various embodiments, each order classification training example includes characteristics of a customer from whom an order was received and attributes of the order received from the customer. A label is applied to each order classification training example, with a label indicating whether the order included in the order classification training example was sporadic. For example, the label has a first value in response to the order included in an order classification training example being sporadic and has a different second value in response to the order included in the order classification training example not being sporadic. Applying the order classification model to multiple training examples generates the parameters (e.g., the weights) for the churn classification model. When applied to a training example, the order classification model generates a predicted probability of the order being sporadic or a predicted indication whether the order is sporadic.

For each order classification training example to which the order classification is applied, the online concierge system 140 generates a score comprising an error term based on the predicted probability or the predicted indication of an order included in the order classification example being sporadic and the label applied to the training example. The error term is larger when a difference between the predicted probability or the predicted indication of an order included in the order classification training example being sporadic and the label applied to the order classification training example is larger and is smaller when the difference between the predicted probability or the predicted indication of an order included in the order classification training example being sporadic and the label applied to the training example is smaller. In various embodiments, the online concierge system 140 generates the error term using a loss function based on a difference between the predicted probability or the predicted indication of an order included in the order classification training example being sporadic and the label applied to the order classification training example using a loss function. Example loss functions include a mean square error function, a mean absolute error, a hinge loss function, and a cross-entropy loss function.

The online concierge system 140 backpropagates the error term to update the set of parameters comprising the order classification model and stops backpropagation in response to the error term, or to the loss function, satisfying one or more criteria. For example, the online concierge system 140 backpropagates the error term through the order classification model to update parameters of the order classification model until the error term has less than a threshold value. For example, the online system 140 may apply gradient descent to update the set of parameters. The online concierge system 140 stores the set of parameters comprising the order classification model on a non-transitory computer readable storage medium after stopping the backpropagation.

Hence, in various embodiments, the online concierge system 140 determines whether a received order from the customer is sporadic. For example, the online concierge system 140 determines the received order is sporadic in response to the order classification model outputting an indication the order is sporadic when applied to characteristics of the customer and attributes of the order. As another example, the online concierge system 140 determines the received order is sporadic in response to a probability output by the order classification model equaling or exceeding a threshold probability. In response to determining the received order is sporadic, the online concierge system 140 does not identify 325 churn of the customer in response to at least the threshold time period passing from a time between the received order determined to be sporadic and the customer performing the specific action again. However, in response to determining the received order is not sporadic, the online concierge system 140 identifies 325 churn of the customer based on a length of time between the received order and the customer performing the specific action, as further described above.

In response to identifying 325 churn of the customer, the online concierge system 140 determines 330 an event to which the identified churn of the customer is attributed. In various embodiments, the online concierge system 140 applies the trained churn classification model to characteristics of the customer, an order received from the customer, and attributes describing fulfillment of the order, such as characteristics of a picker fulfilling the order, as further described above. The churn classification model determines 330 one or more events to which the identified churn of the customer is attributed to identify an event affecting fulfillment of the order most likely to cause the churn identified 325 for the customer.

To mitigate the identified churn, which increases a likelihood of the customer performing the specific action with the online concierge system 140 within the threshold time period, the online concierge system 140 applies 335 the picker scoring model to each of at least a set of pickers. For each picker of the set, the online concierge system 140 applies 335 the picker scoring model to characteristics of the customer for whom churn was identified 325, one or more orders received from the customer for whom churn was identified 325, the event to which the churn of the customer is attributed, and characteristics of the picker. The one or more orders received from the customer for whom churn was identified 325 include an order fulfilled by the online concierge system 140 nearest to when the online concierge system 140 identified 325 churn of the customer. In some embodiments, the set of pickers includes pickers available to fulfill an order within a specific time interval, such as within the specific time interval from when churn was identified 325. As another example, the set of pickers includes pickers within a threshold distance of a location associated with the customer by the online concierge system 140.

Applying the picker scoring model to each of at least the set of pickers generates a picker score for each picker of the set. As a picker score for a picker is a probability that the picker fulfilling an order for the customer causes the customer to perform specific action with the online concierge system 140 (e.g., place an additional order with the online concierge system 140) within the threshold time period, the picker score for different pickers of the set indicate probabilities of that each picker of the set fulfilling the order decreasing an amount of time until the picker performs the specific action with the online concierge system 140. Based on the picker scores for the pickers of the set, the online concierge system 140 selects 340 a specific picker of the set to fulfill a subsequent order from the customer. As the characteristics of the pickers from which picker scores are determined include one or more areas of expertise of the picker and the picker scoring model receives the event to which churn of the customer was attributed, the picker scores account for differing areas of expertise of pickers differently compensating for the determined event to which churn of the customer was attributed. For example, the picker score for a picker with an expertise that is mapped to the determined event to which churn of the customer was attributed is higher than the picker score for another picker with a different expertise that is not mapped to the determined event to which churn of the customer was attributed. This increases a likelihood of the online concierge system 140 selecting 340 a specific picker with an expertise best suited to mitigate the event to which churn of the customer was attributed when selecting 340 the specific picker based on picker scores.

In some embodiments, the online concierge system 140 selects 340 a specific picker having a maximum picker score to fulfill a subsequent order from the customer. As another example, the online concierge system 140 ranks pickers of the set by picker scores and selects 340 a specific picker having a maximum position in the ranking, or having a threshold position in the ranking. In various embodiments, the online concierge system 140 accounts for availability of pickers of the set to fulfill a subsequent order from the customer by filtering the set of pickers to remove pickers who are unavailable during a time interval identified by the subsequent order or who have less than a threshold availability during the time interval identified by the subsequent order. For example, the online concierge system 140 selects 340 a specific picker in the filtered set having a maximum picker score or having at least a threshold position (e.g., a maximum position) in a ranking of pickers of the set based on corresponding picker scores. Selecting 340 the specific picker based on picker scores to fulfill a subsequent order from the customer increases a likelihood of the customer performing the specific action with the online concierge system 140 more frequently.

FIG. 4 is a process flow diagram of a method for selecting a picker for fulfilling an order for a customer of an online concierge system 140 who has at least a threshold probability of not performing a specific action with the online concierge system 140 within a threshold time period. The online concierge system 140 receives various interactions from a customer 400 over time. Example interactions with the online concierge system 140 include placing an order with the online concierge system 140, requesting information about one or more items from the online concierge system 140, browsing items offered by one or more retailers via the online concierge system 140, providing feedback about fulfillment of an order to the online concierge system 140, or other interactions with the online concierge system 140. The online concierge system 140 uses occurrences of specific actions, such as placing orders with the online concierge system 140, to gauge user engagement with the online concierge system 140. For example, the online concierge system 140 determines user engagement based on a frequency with which a customer performs a specific action or based on a length of time between successive occurrences of the specific action.

To maintain or to increase user interaction with the online concierge system 140, the online concierge system 140 evaluates customer interactions over time to identify “churn” for a customer 400. Churn of the customer 400 occurs when the customer 400 fails to perform a specific action (e.g., placing an order) with the online concierge system 140 within a threshold time period. For example, the online concierge system 140 identifies 405 churn of the customer 400 when the customer 400 performs the specific action and does not perform the specific action again within the threshold time period. As another example, the online concierge system 140 identifies 405 churn of the customer 400 in response to the customer performing an interaction with the online concierge system 140 and failing to perform the specific action within the threshold time period of performing the interaction.

In other embodiments, the online concierge system 140 applies a churn prediction model to prior interactions of the customer 400 with the online concierge system 140 to identify 405 churn of the customer 400. The prior interactions of the customer 400 include characteristics of the customer 400 and attributes describing fulfillment of an order for the customer 400 in various embodiments. Attributes describing fulfillment of the order may include characteristics of a picker who fulfilled an order for the customer 400 and attributes of the order. The churn prediction model determines a probability of churn occurring for the customer 400 (i.e., a probability of the customer 400 failing to perform the specific action within the threshold time period) based on the prior interactions of the customer with the online concierge system 140, as further described above in conjunction with FIG. 3. The online concierge system 140 identifies 405 churn of the customer 400 in response to the probability of the customer 400 failing to perform the specific action within the threshold time period equaling or exceeding a threshold probability.

Identifying 405 churn of the customer 400 indicates a decrease in frequency with which the customer 400 interacts with the online concierge system 140. To increase the frequency of interaction with the online concierge system 140, the online concierge system 140 applies a churn classification model 410, trained as further described above in conjunction with FIG. 3, to characteristics of the customer 400, an order received from the customer 400, and attributes describing fulfillment of the order, such as characteristics of a picker fulfilling the order. The churn classification model 410 determines an event 415 to which churn of the customer is attributed. An “event” identifies one or more factors affecting fulfillment of an order, such as one or more factors delaying fulfillment of an order or preventing a picker from obtaining all items included in an order. Example events causing churn of the customer include: fulfilling an order later than a time interval specified by the order, inclusion of replacement items in the order rather than items identified by the order, inadequate communication between a picker fulfilling the order with the customer, an amount of compensation the customer paid the online concierge system 140 for fulfilling the order, a number of items included in the order that were not obtained by the picker, or other actions affecting fulfillment of an order.

To mitigate churn identified 405 for the customer 400, the online concierge system 140 may perform one or more remedial actions to mitigate the event 415 to which the churn was attributed, with a remedial action reducing a likelihood of the event 415 occurring when fulfilling a subsequent order from the customer 400. As different remedial actions mitigate different events, determining the event 415 to which the churn was attributed allows the online concierge system 140 to perform an optimal remedial action to decreasing the likelihood of the event 415 occurring during fulfillment of a subsequent order. In various embodiments, the online concierge system 140 mitigates churn of the customer 400 by tailoring selection of a picker to fulfill a subsequent order from the customer 400 based on the event 415 to which the churn was attributed.

In various embodiments, the online concierge system 140 maintains a mapping between events to which churn of a customer is attributed and areas of expertise of pickers. An expertise of a picker mapped to an event indicates the expertise mitigates effects of the event on order fulfillment. For example, the mapping associates an event of inclusion of items in an order with which the customer was dissatisfied with an expertise of obtaining items from a specific retailer or with an expertise of obtaining items in a specific item category. As another example, the mapping associates an event of fulfilling an order later than a time interval included in the order with an expertise of rapid fulfillment of orders. Hence, the mapping allows the online concierge system 140 to identify an expertise that compensates for one or more effects of an event on order fulfillment.

To select a picker for fulfilling an order from the customer 400 after identifying 405 churn of the customer 400, the online concierge system 140 trains a picker scoring model 420, as further described above in conjunction with FIG. 3. The picker scoring model 420 receives characteristics 425 of the customer 400, one or more prior orders 430 received from the customer 400, the event 415 to which churn of the customer 400 was attributed, and characteristics 435 of a picker. The characteristics 435 of a picker include one or more areas of expertise of the picker, with other example characteristics 435 of a picker including an availability of the picker for fulfilling orders, fulfillment of one or more prior orders by the picker, whether the picker fulfilling one or more prior orders decreased an amount of time for customers corresponding to the prior orders placing subsequent orders, or other characteristics of the picker affecting order fulfillment.

In various embodiments, the prior orders 430 received from the customer 400 include an order received most recently before the online concierge system 140 identified 405 churn of the customer 400, as well as one or more additional orders. The additional orders may have at least a threshold measure of similarity to the order received most recently before identifying 405 churn of the customer 400. For example, the online concierge system 140 retrieves additional orders received before identifying 405 churn of the customer 400, with each additional order having an embedding with a threshold measure of similarity (e.g., dot product, cosine similarity) to an embedding of the order received most recently before identifying 405 churn of the customer 400.

Based on the characteristics 425 of the customer 400, the one or more prior orders 430 received from the customer 400, the event 415 to which churn of the customer 400 was attributed, and the characteristics 435 of a picker, the picker scoring model 420 determines a picker score 440 for the picker. As further described above in conjunction with FIGS. 2 and 3, the picker score 440 for the picker is a probability that the picker fulfilling a subsequent order for the customer 400 causes the customer 400 to perform the specific action with the online concierge system 140 (e.g., place an additional order with the online concierge system 140) within the threshold time period. For example, the picker score 440 for a picker is a probability that the customer 400 places an additional order within the threshold time period after the picker fulfills a subsequent order from the customer 400.

In various embodiments, a picker score 440 for a picker is higher when an expertise of the picker is mapped to an event 415 to which churn of the customer 400 is attributed. This allows the picker score 440 to account for effectiveness of an expertise of the picker in mitigating the event 415 to which churn of the customer 400 is attributed. For example, a picker with an expertise of obtaining items at a specific retailer has a higher picker score 440 when the event 415 to which churn of the customer 400 is attributed is selection of unsatisfactory items from the specific retailer or is inability to obtain items from the specific retailer. Hence, pickers with different areas of expertise have different picker scores 440 based on the event 415 to which churn of the customer 400 is attributed.

In various embodiments, the online concierge system 140 applies the picker scoring model 420 to each picker of a set of pickers to generate a picker score 440 for each picker of the set. Based on the picker scores 440, the online concierge system 140 selects a specific picker for fulfilling a subsequent order from the customer, as further described above in conjunction with FIG. 3. For example, the online concierge system 140 selects a specific picker having a maximum picker score to fulfill a subsequent order from the customer 400.

In some embodiments, the online concierge system 140 transmits an offer to the customer 400 including a discount or other benefit to the customer 400 for a subsequent order, with the specific picker selected to fulfill an order in response to the offer. For example, the offer comprises a notification message transmitted from the online concierge system 140 to a customer client device 100 of the customer 400 including a discount or other compensation from the online concierge system 140 to the customer 400 and an interface element. In response to the customer selecting the interface element, the online concierge system 140 prompts the customer to provide information for an order to be fulfilled by the specific picker. The online concierge system 140 determines an expected value of transmitting an offer to the customer 400 in various embodiments and transmits the offer to the customer in response to the expected value equaling or exceeding a threshold value. For example, the online system determines a product of a value from the customer interacting with the online concierge system 140 and a probability of the customer performing the specific action within the threshold time period of fulfilling an order based on the offer (which may be determined by subtracting the picker score of the specific picker from 1 in some embodiments). The online concierge system 140 determines the expected value for the customer by subtracting a cost to the online concierge system 140 of the offer from the determined product. If the expected value equals or exceeds a threshold value, the online concierge system 140 transmits the offer to the customer.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
identifying churn of a customer of the computer system, wherein churn of the customer indicates a decrease in interaction by the customer with the computer system;
identifying an event to which the churn of the customer is attributed, wherein the identifying is based on characteristics of the customer and attributes describing fulfillment of one or more orders received from the customer;
generating a picker score for each of a set of pickers, the picker score for a picker comprising a probability of the customer performing a specific action within a threshold time period of the picker fulfilling a subsequent order from the customer, the picker score generated by applying a picker scoring model to the characteristics of the customer, characteristics of the picker, the identified event, and one or more prior orders from the customer, the picker scoring model trained by:
obtaining a score training dataset including a plurality of score training examples, each score training example including characteristics of a customer included in the score training example, characteristics of a picker included in the score training example, an event to which churn of the customer included in the score training example was attributed, and one or more prior orders from the customer included in the score training example, each score training example having a label indicating whether the customer in the score training example performed the specific action within the threshold time period after fulfillment of an order by the picker in the score training example;
applying the picker scoring model to each training example of the training dataset to generate a predicted probability of the customer in the score training example performing the specific action within the threshold time period after fulfillment of an order by the picker in the score training example;
scoring the picker scoring model using a loss function and the label of the score training example; and
updating one or more parameters of the picker scoring model by backpropagation based on the scoring until one or more criteria are satisfied; and
selecting, based on the picker scores, a picker of the set of pickers to fulfill the subsequent order from the customer.

2. The method of claim 1, wherein characteristics of the picker include an expertise of the picker.

3. The method of claim 2, further comprising:
maintaining a mapping of the event to which the churn of the customer is attributed to a corresponding expertise that mitigates the event,
wherein selecting the picker of the set of pickers to fulfill the subsequent order is based on the mapping.

4. The method of claim 3, wherein a picker score for a picker with an expertise mapped to the event to which the churn of the customer is attributed is higher than a picker score for an alternative picker with an expertise that is not mapped to the event to which the churn of the customer is attributed.

5. The method of claim 1, wherein identifying churn of the customer of the computer system comprises:
determining the threshold time period lapsed between the customer performing a specific action and the customer performing the specific action again.

6. The method of claim 5, wherein the specific action comprises the customer placing an order with the computer system.

7. The method of claim 1, wherein identifying churn of the customer of the computer system comprises:
applying a churn prediction model to prior interactions of the customer with the computer system, the churn prediction model determining a probability of the customer failing to perform the specific action within the threshold time period based on characteristics of the customer and attributes describing fulfillment of one or more orders for the customer; and
identifying churn of the customer in response to the probability of the customer failing to perform the specific action within the threshold time period equaling or exceeding a threshold probability.

8. The method of claim 1, wherein identifying the event to which the churn of the customer is attributed based on characteristics of the customer and attributes describing fulfillment of one or more orders received from the customer comprises:
applying a churn classification model generating the event to which the churn of the customer is attributed to the characteristics of the customer, an order received from the customer, and the attributes describing fulfillment of the order, such as characteristics of a picker fulfilling the order, the churn classification model trained by:
obtaining a training dataset including a plurality of training examples, each training example includes characteristics of a customer associated with an indication of churn, an order received from the customer associated with the indication of churn, and attributes describing fulfillment of the order for the customer associated with the indication of churn and each training example having a label specifying an event causing the churn of the customer associated with the indication of churn;
applying the churn classification model to each training example of the training dataset to generate a predicted event causing churn of the customer associated with the indication of churn;
scoring the churn classification model using a loss function and the label of the training example; and
updating one or more parameters of the churn classification model by backpropagation based on the scoring until one or more criteria are satisfied.

9. The method of claim 1, wherein the characteristics of the customer include an order received by the computing system most recently before identifying churn of the customer, as well as one or more additional orders.

10. The method of claim 9, wherein the characteristics of the customer further include one or more additional orders from the customer, each additional order having at least a threshold measure of similarity to the order received most recently before identifying churn of the customer.

11. The method of claim 1, further comprising:
transmitting an offer to place an order to a customer client device of the customer, the offer including a discount to the customer for the order, with the specific picker selected to fulfill the order.

12. A computer program product comprising a non-transitory computer readable storage medium having instructions encoded thereon that, when executed by a processor, cause the processor to perform steps comprising:
identifying churn of a customer of a computer system, wherein churn of the customer indicates a decrease in interaction by the customer with the computer system;
identifying an event to which the churn of the customer is attributed, wherein the identifying is based on characteristics of the customer and attributes describing fulfillment of one or more orders received from the customer;
generating a picker score for each of a set of pickers, the picker score for a picker comprising a probability of the customer performing a specific action within a threshold time period of the picker fulfilling a subsequent order from the customer, the picker score generated by applying a picker scoring model to the characteristics of the customer, characteristics of the picker, the identified event, and one or more prior orders from the customer, the picker scoring model trained by:
obtaining a score training dataset including a plurality of score training examples, each score training example including characteristics of a customer included in the score training example, characteristics of a picker included in the score training example, an event to which churn of the customer included in the score training example was attributed, and one or more prior orders from the customer included in the score training example, each score training example having a label indicating whether the customer in the score training example performed the specific action within the threshold time period after fulfillment of an order by the picker in the score training example;
applying the picker scoring model to each training example of the training dataset to generate a predicted probability of the customer in the score training example performing the specific action within the threshold time period after fulfillment of an order by the picker in the score training example;
scoring the picker scoring model using a loss function and the label of the score training example; and
updating one or more parameters of the picker scoring model by backpropagation based on the scoring until one or more criteria are satisfied; and
selecting, based on the picker scores, a picker of the set of pickers to fulfill the subsequent order from the customer.

13. The computer program product of claim 12, wherein characteristics of the picker include an expertise of the picker.

14. The computer program product of claim 13, wherein the non-transitory computer readable storage medium further has instructions encoded thereon that, when executed by a processor, cause the processor to perform steps comprising:
maintaining a mapping of the event to which the churn of the customer is attributed to a corresponding expertise that mitigates the event,
wherein selecting the picker of the set of pickers to fulfill the subsequent order is based on the mapping.

15. The computer program product of claim 14, wherein a picker score for a picker with an expertise mapped to the event to which the churn of the customer is attributed is higher than a picker score for an alternative picker with an expertise that is not mapped to the event to which the churn of the customer is attributed.

16. The computer program product of claim 12, wherein identifying churn of the customer of the computer system comprises:
determining the threshold time period lapsed between the customer performing a specific action and the customer performing the specific action again.

17. The computer program product of claim 12, wherein identifying the event to which the churn of the customer is attributed based on characteristics of the customer and attributes describing fulfillment of one or more orders received from the customer comprises:
applying a churn classification model generating the event to which the churn of the customer is attributed to the characteristics of the customer, an order received from the customer, and the attributes describing fulfillment of the order, such as characteristics of a picker fulfilling the order, the churn classification model trained by:
obtaining a training dataset including a plurality of training examples, each training example includes characteristics of a customer associated with an indication of churn, an order received from the customer associated with the indication of churn, and attributes describing fulfillment of the order for the customer associated with the indication of churn and each training example having a label specifying an event causing the churn of the customer associated with the indication of churn;
applying the churn classification model to each training example of the training dataset to generate a predicted event causing churn of the customer associated with the indication of churn;
scoring the churn classification model using a loss function and the label of the training example; and
updating one or more parameters of the churn classification model by backpropagation based on the scoring until one or more criteria are satisfied.

18. The computer program product of claim 12, wherein the characteristics of the customer include an order received by the computer system most recently before identifying churn of the customer, as well as one or more additional orders.

19. The computer program product of claim 18, wherein the characteristics of the customer further include one or more additional orders from the customer, each additional order having at least a threshold measure of similarity to the order received most recently before identifying churn of the customer.

20. A computing system comprising:
one or more processors; and
a non-transitory computer readable storage medium having instructions encoded thereon that, when executed by the processor, cause the processor to perform steps comprising:
identifying churn of a customer of the computer system, wherein churn of the customer indicates a decrease in interaction by the customer with the computer system;
identifying an event to which the churn of the customer is attributed, wherein the identifying is based on characteristics of the customer and attributes describing fulfillment of one or more orders received from the customer;
generating a picker score for each of a set of pickers, the picker score for a picker comprising a probability of the customer performing a specific action within a threshold time period of the picker fulfilling a subsequent order from the customer, the picker score generated by applying a picker scoring model to the characteristics of the customer, characteristics of the picker, the identified event, and one or more prior orders from the customer, the picker scoring model trained by:
obtaining a score training dataset including a plurality of score training examples, each score training example including characteristics of a customer included in the score training example, characteristics of a picker included in the score training example, an event to which churn of the customer included in the score training example was attributed, and one or more prior orders from the customer included in the score training example, each score training example having a label indicating whether the customer in the score training example performed the specific action within the threshold time period after fulfillment of an order by the picker in the score training example;
applying the picker scoring model to each training example of the training dataset to generate a predicted probability of the customer in the score training example performing the specific action within the threshold time period after fulfillment of an order by the picker in the score training example;
scoring the picker scoring model using a loss function and the label of the score training example; and
updating one or more parameters of the picker scoring model by backpropagation based on the scoring until one or more criteria are satisfied; and
selecting, based on the picker scores, a picker of the set of pickers to fulfill the subsequent order from the customer.
